(19) United States
(12) Patent Application Publication
(10) Pub. No.: US 2014/0188644 A1
(43) Pub. Date: Jul. 3, 2014

(54) METHOD AND SYSTEM FOR IMPLEMENTING A CONSUMER ENTITLEMENT PROGRAM

(71) Applicant: Richard Postrel, Miami Beach, FL (US)

(72) Inventor: Richard Postrel, Miami Beach, FL (US)

(21) Appl. No.: 14/136,398

(22) Filed: Dec. 20, 2013

Related U.S. Application Data
(60) Provisional application No. 61/747,433, filed on Dec. 31, 2012.

(51) Int. Cl. G06Q 20/40; G06Q 20/24; G06Q 20/20

(52) U.S. Cl. CPC G06Q 20/40; G06Q 20/202; G06Q 20/24
USPC 705/21

(57) ABSTRACT

A managed credit system and method including a POS computer and a credit server computer interconnected via a computer network. The credit server computer includes a credit account database on which a credit account associated with a consumer is established, a purchase rules database on which a set of purchase rules is stored, and processing circuitry programmed to receive from the point of sale device a purchase request comprising an identification of the consumer and a price of the product. The processing circuitry is also programmed to determine if the purchase request should be authorized by (i) ascertaining if the purchase request complies with the set of purchase rules and (ii) verifying that the credit account contains credits sufficient to pay for the purchase request.

### BACKGROUND OF THE INVENTION

Programs are currently implemented by governmental agencies that provide assistance and other forms of entitlement to consumers based upon parameters such as need, income amounts, physical condition including disabilities, etc. For example, the United States federal government provides assistance to low income citizens known as food stamps. Food stamps may be used as tender for the recipients to purchase certain items of need from stores such as groceries and medicines.

These governmental assistance programs attempt to limit the types of purchases that a recipient may make, such as by disallowing beer and alcohol purchases. However, abuses of the system are prevalent. For example, food stamps are often sold by recipients for cash that the recipient uses to purchase otherwise disallowed items such as beer, or even illegal drugs. Attempts by the governmental agencies to curtail these abuses of the system are often met with failure.

### SUMMARY OF THE INVENTION

Provide is a managed credit system and method that includes a point of sale device and a credit server computer interconnected with the point of sale device via a computer network. The credit server computer includes a credit account database on which a credit account associated with a consumer is established, wherein the credit account is funded on a periodic basis with a predetermined number of credits. The credit server computer also includes a purchase rules database on which a set of purchase rules is stored. The credit server computer includes processing circuitry programmed to receive from the point of sale device via the computer network a purchase request, the purchase request comprising an identification of the consumer and a price of the product requested to be purchased by the consumer. The processing circuitry is also programmed to determine if the purchase request should be authorized by (i) ascertaining if the purchase request complies with the set of purchase rules and (ii) verifying that the credit account contains credits sufficient to pay for the purchase request.

The purchase request may also include an identification of a product requested to be purchased by the consumer, an identification of a merchant selling a product requested to be purchased by the consumer, an identification of the point of sale device, and/or an identification of a token utilized by the consumer to make the purchase request

The set of purchase rules may include a purchase rule associated with a product category and/or a product price. The purchase rules may include a global purchase rule applicable to a plurality of consumers, and/or it may include a consumer-specific purchase rule applicable to the consumer. The purchase rules may include a purchase rule associated with a day of week and/or a time of day.

In one example, the managed credit system may be a food stamp system. In another example, the managed credit system may be an emergency fund distribution system.

### BRIEF DESCRIPTION OF THE DRAWING

FIG. 1 is a block diagram of the system of the present invention.

FIG. 2 is a flowchart of the basic operation of the present invention.

### DESCRIPTION OF THE INVENTION

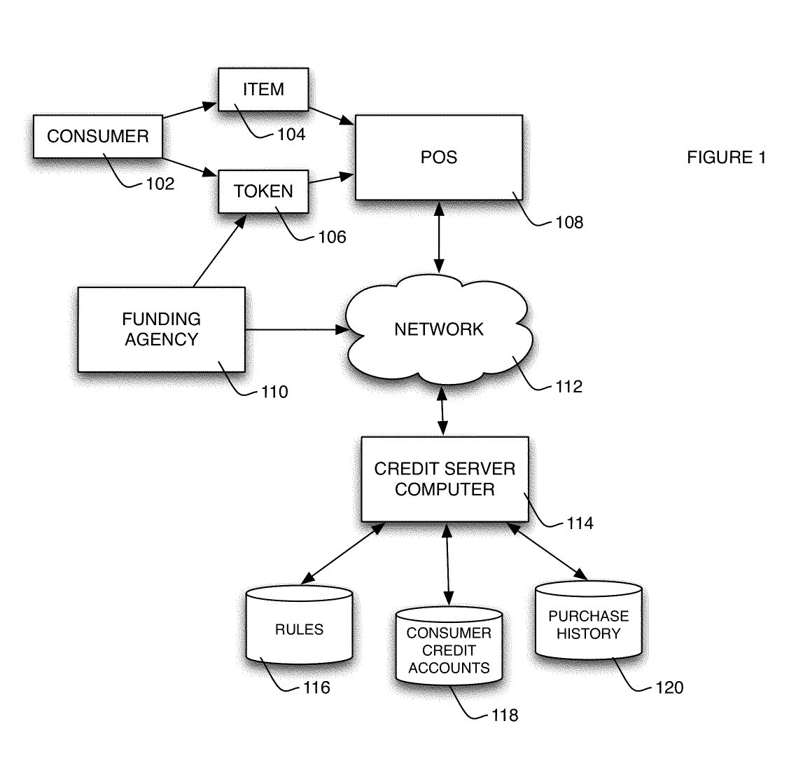

Provided is a method and system for implementing a consumer entitlement program that overcomes these problems of the prior art. With reference to FIG. 1, a credit server computer 114 is established that holds a consumer credit account in account database 118 on behalf of each consumer 102 that is registered in the system. Each consumer 102 receives an allocation of credits into his or her account, based on a set of rules that are established and stored in a rules database 116 associated with the credit server computer 114. The credit server computer 114 communicates with a computer network 112, for example the credit card or debit card network infrastructure being implemented by the credit card and debit card systems already in use by almost every merchant. In the alternative, a network such as the Internet may be used with this invention.

Each registered consumer 102 is provided with a token 106 such as a card (e.g. magnetic stripe card, smart card etc.) which serves to identify that consumer to the system in a manner similar to a credit card. In the alternative, the token may be embedded in a portable computing device such as an IPHONE or ANDROID based smartphone, for example by use of NFC (near field communications) technology as well known in the art. When the consumer desires to purchase an item 104, he presents that item to a point of sale (POS) device 108, which may be at a merchant location or an online terminal such as a smartphone, tablet, computer and the like. The consumer also presents his token 106 to make the purchase, which will appear to the POS 108 as a typical credit card transaction. The POS device enters the card information, for example by swiping it through a magnetic stripe reader.

The purchase authorization process is transparent to the merchant and the POS terminal 108 and appears to be a typical credit card transaction. However, the processor routes the purchase authorization request to the credit server computer 114. The purchase authorization request will include at least the consumer identification from the token that was presented, as well as optionally one or more of: an identification of the item requested to purchase (e.g. the UPC number scanned from the item packaging); an identification of the merchant selling the product requested to be purchased by the consumer; an identification of the point of sale device; and/or an identification of the token utilized by the consumer to make the purchase request. The purchase price is also included in the purchase request.

The server computer 114 will receive the purchase request and refer to the rules database 116 to determine if the purchase will be authorized or denied. The rules database may include rules that govern only the consumer identification as well as other pieces of information. For example, a rule may be established that excludes all purchase requests made by a certain consumer, such as if a certain consumer has been removed from the program. This may also be based on certain days of the week or times of the day. For example, a rule may be established that states that consumer John Smith is unable to make any purchases on a Saturday, or unable to make any purchases after 10 PM, etc.

The rules database may also include rules that apply to purchase requests made for certain products. For example, a purchase request made for liquor may be forbidden. Or, any purchase made for bread may be allowed. This type of rule may also be combined with the day of the week, time of the day, and/or consumer identification, if desired.

The rules database may also include rules that apply to purchase requests made at certain merchants. For example, any purchase request made at any liquor store may be forbidden. Or, any purchase made at TARGET stores may be allowed. This type of rule may also be combined with the day of the week, time of the day, and/or consumer identification, if desired.

The rules database may also include rules that apply to purchase requests made based on the point of sale device being used, or with an identification of the token being used, in a manner similar to what has been described above.

Thus, the rules database 116 may contain consumer-specific as well as global rules that govern the authorization of purchases. For example, a global rule may disallow all purchases of alcoholic beverages. Or, the rule may disallow the purchase of alcoholic beverages on certain days, or at certain times.

The consumer credit account may also be accessed from the database 118 in conjunction with the rules database 116. A purchase history database 120 is also accessed, which contains a purchase history component that records each purchase made by that consumer. This is used to put limits on certain items that may be purchased. For example, a rule may be established that provides that a consumer may purchase $20 worth of snacks in a month. Once that limit has been reached, then any subsequent snack food purchase will be denied until a new month begins. Also, once the consumer's credit account is exhausted, then all attempted purchases will be denied until the account is replenished.

For example, a food stamp program may provide a consumer with a spouse and 2 children with $400 per month in allowable purchases, as follows:

$100 diary products

$100 meat products

$100 produce products

$50 staple goods

$30 soft drinks

$20 snack foods

As purchases are made throughout the month, each category is tracked in database 120 so that the consumer does not exceed the allocated amount in a given category or overall.

Allocating food purchases has many benefits, including the elimination of the black market for food stamps as in the prior art. Since the user is given a card that may have a photo ID on it, only that user would be able to use it. It would be treated in the same manner as a credit card and use the same security features in order to ensure that the system rules are followed. This will result in more effective administration of the program by the administering agency, with less waste and fraud than in current systems.

Tracking food purchases also provides many benefits. For example, the system can ascertain which users are purchasing which types of products and tailor the system accordingly. If it is determined that certain consumers are purchasing unhealthy food items, rules can be tailored to disallow those purchases in the future. Also, consumers may be given bonus credits in exchange for making healthy food purchases. For example a consumer that purchases low fat dairy products may be given a higher allotment than those who do not, either relatively or in an absolute amount.

By using the system of the present invention it is easier to distribute money, in the form of credits, in a quick and efficient manner as compared to the prior art systems. For example, on the first of each month, each consumer may have his allotment refilled without having to incur mailing costs or delays of current food stamp systems.

This invention may also be useful in distributing emergency funds to consumers after a natural disaster such as a hurricane. The agency FEMA often attempts to distribute checks to people who have lost their homes in a hurricane. This money is to be used for short term housing costs as well as long term rebuilding. The consumer's account can be funded immediately by the funding agency 110, and rules may be established to control spending such as amounts that may be spent at a hotel, types of home improvement purchases, etc.

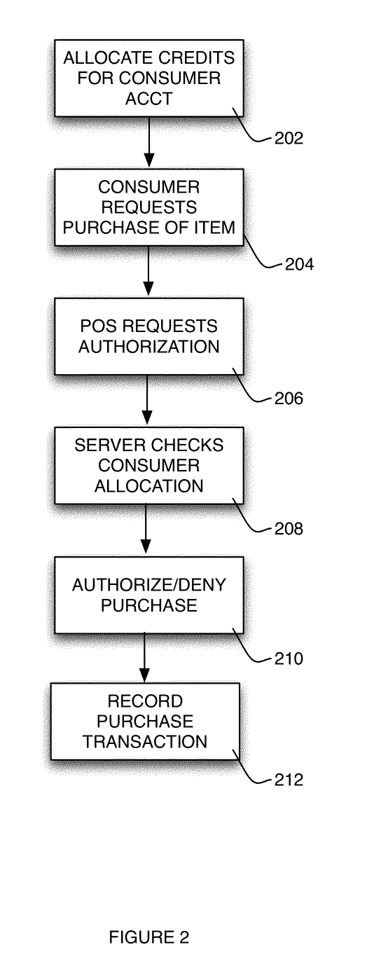

The method as describe above is set forth in the flowchart of FIG. 2. At step 202, credits are allocated to a consumer account. At step 204, the consumer requests the purchase of an item at a POS terminal. At step 206, the POS terminal requests purchase authorization from the server computer via the network. This authorization request includes an identification of the consumer, an identification of the item being purchased, and the price of the item. At step 208, the server computer checks the consumer allocation by referring to the credit account database 118, the rules database 116, and the purchase history database 120. At step 210, the server computer issues a denial or authorization of the purchase by the consumer. At step 212, the purchase is recorded in the database 120 (assuming it was authorized and executed at the POS).

What is claimed is:

1. A method of implementing a managed credit system comprising:
establishing in a credit account database at a credit server computer a credit account associated with a consumer,
storing in a purchase rules database at the credit server computer a set of purchase rules,
funding the credit account on a periodic basis with a predetermined number of credits,
the credit server computer receiving from a point of sale device via a computer network a purchase request, the purchase request comprising an identification of the consumer and a price of the product requested to be purchased by the consumer,
the credit server computer determining if the purchase request should be authorized by (i) ascertaining if the purchase request complies with the set of purchase rules and (ii) verifying that the credit account contains credits sufficient to pay for the purchase request.

2. The method of claim 1 wherein the purchase request further comprises an identification of a product requested to be purchased by the consumer.

3. The method of claim 1 wherein the purchase request further comprises an identification of a merchant selling a product requested to be purchased by the consumer.

4. The method of claim 1 wherein the purchase request further comprises an identification of the point of sale device.

5. The method of claim 1 wherein the purchase request further comprises an identification of a token utilized by the consumer to make the purchase request.

6. The method of claim 1 wherein the set of purchase rules comprises a purchase rule associated with a product category.

7. The method of claim 1 wherein the set of purchase rules comprises a purchase rule associated with a product price.

8. The method of claim 1 wherein the set of purchase rules comprises a global purchase rule applicable to a plurality of consumers.

9. The method of claim 1 wherein the set of purchase rules comprises a consumer-specific purchase rule applicable to the consumer.

10. The method of claim 1 wherein the set of purchase rules comprises a purchase rule associated with a day of week.

11. The method of claim 1 wherein the set of purchase rules comprises a purchase rule associated with a time of day.

12. The method of claim 1 wherein the managed credit system is a food stamp system.

13. The method of claim 1 wherein the managed credit system is an emergency fund distribution system.

14. A managed credit system comprising:
a point of sale computer; and
a credit server computer interconnected with the point of sale computer via a computer network, the credit server computer comprising
a credit account database on which a credit account associated with a consumer is established, wherein the credit account is funded on a periodic basis with a predetermined number of credits,
a purchase rules database on which a set of purchase rules is stored, and
processing circuitry programmed to
receive from the point of sale device via the computer network a purchase request, the purchase request comprising an identification of the consumer and a price of the product requested to be purchased by the consumer,
determine if the purchase request should be authorized by (i) ascertaining if the purchase request complies with the set of purchase rules and (ii) verifying that the credit account contains credits sufficient to pay for the purchase request.

15. The system of claim 14 wherein the purchase request further comprises an identification of a product requested to be purchased by the consumer.

16. The system of claim 14 wherein the purchase request further comprises an identification of a merchant selling a product requested to be purchased by the consumer.

17. The system of claim 14 wherein the purchase request further comprises an identification of the point of sale device.

18. The system of claim 14 wherein the purchase request further comprises an identification of a token utilized by the consumer to make the purchase request.

19. The system of claim 14 wherein the set of purchase rules comprises a purchase rule associated with a product category.

20. The system of claim 14 wherein the set of purchase rules comprises a purchase rule associated with a product price.

21. The system of claim 14 wherein the set of purchase rules comprises a global purchase rule applicable to a plurality of consumers.

22. The system of claim 14 wherein the set of purchase rules comprises a consumer-specific purchase rule applicable to the consumer.

23. The system of claim 14 wherein the set of purchase rules comprises a purchase rule associated with a day of week.

24. The system of claim 14 wherein the set of purchase rules comprises a purchase rule associated with a time of day.

25. The system of claim 14 wherein the managed credit system is a food stamp system.

26. The system of claim 14 wherein the managed credit system is an emergency fund distribution system.

27. A credit server computer comprising:
a credit account database on which a credit account associated with a consumer is established, wherein the credit account is funded on a periodic basis with a predetermined number of credits,
a purchase rules database on which a set of purchase rules is stored, and
processing circuitry programmed to
receive from a point of sale device via a computer network a purchase request, the purchase request comprising an identification of the consumer and a price of the product requested to be purchased by the consumer,
determine if the purchase request should be authorized by (i) ascertaining if the purchase request complies with the set of purchase rules and (ii) verifying that the credit account contains credits sufficient to pay for the purchase request.

28. The credit server computer of claim 27 wherein the purchase request further comprises an identification of a product requested to be purchased by the consumer.

29. The credit server computer of claim 27 wherein the purchase request further comprises an identification of a merchant selling a product requested to be purchased by the consumer.

30. The credit server computer of claim 27 wherein the purchase request further comprises an identification of the point of sale device.

31. The credit server computer of claim 27 wherein the purchase request further comprises an identification of a token utilized by the consumer to make the purchase request.

32. The credit server computer of claim 27 wherein the set of purchase rules comprises a purchase rule associated with a product category.

33. The credit server computer of claim 27 wherein the set of purchase rules comprises a purchase rule associated with a product price.

34. The credit server computer of claim 27 wherein the set of purchase rules comprises a global purchase rule applicable to a plurality of consumers.

35. The credit server computer of claim 27 wherein the set of purchase rules comprises a consumer-specific purchase rule applicable to the consumer.

36. The credit server computer of claim 27 wherein the set of purchase rules comprises a purchase rule associated with a day of week.

37. The credit server computer of claim 27 wherein the set of purchase rules comprises a purchase rule associated with a time of day.

38. The credit server computer of claim 27 wherein the managed credit system is a food stamp system.

39. The credit server computer of claim 27 wherein the managed credit system is an emergency fund distribution system.
